(19) United States
(12) Patent Application Publication
(10) Pub. No.: US 2013/0090808 A1
(43) Pub. Date: Apr. 11, 2013

(54) MULTI-FUNCTION DAMPER SYSTEM

(71) Applicants: Charles Lemme, Tucson, AZ (US); William Richards, Tucson, AZ (US)

(72) Inventors: Charles Lemme, Tucson, AZ (US); William Richards, Tucson, AZ (US)

(21) Appl. No.: 13/703,862

(22) PCT Filed: Feb. 17, 2012
(86) PCT No.: PCT/US2012/025690

§ 371 Date: Dec. 12, 2012

Related U.S. Application Data
(60) Provisional application No. 61/445,378, filed on Feb. 22, 2011.

(51) Int. Cl. B60G 17/017; B60G 11/26

(52) U.S. Cl. CPC B60G 17/017; B60G 11/265
USPC 701/37; 280/124.159

(57) ABSTRACT

The embodiments of the invention are directed to a method and apparatus for improvement in the function of dampers used on mobile vehicles such as recreational vehicles. The main function of current dampers (sometimes called shock absorbers) is to extract energy from the suspension system of a moving vehicle by forcing liquid through a system of valves internal to the damper. This invention adds two more functions. One is to lock the suspension so it cannot move when the vehicle is stationary. The second additional function is to level the chassis of the vehicle with respect to the gravity field.

### CROSS REFERENCE TO RELATED APPLICATIONS

This application claims priority from U.S. Provisional Patent Application Ser. No. 61/445,378 filed Feb. 22, 2011, the contents of which are incorporated herein by reference.

### BACKGROUND OF THE INVENTION

The basic structure of vehicles can be divided into two major systems. The occupants ride in the upper system which is a rigid but movable platform called the chassis (also known as the sprung mass) which consists of all the structure that is supported by the springs. The second system consists of the wheels, brakes, axle, a portion of the spring mass and related components which are collectively known as the un-sprung mass (also referred to as the suspension). These are connected to each other by the springs, which allow relative motion and support the mass of the chassis, by some control links that limit relative travel in the vertical direction, and by dampers that absorb energy from the relative motion between the two systems. Vehicles have one set of wheels in the front that are used to steer the vehicle. Only one axle at the rear with one wheel on each end will be described in the rest of this disclosure even though there can be two axles in tandem at the rear, with each axle having dual wheels at each end. These extra axles and wheels, that are sometimes found at the rear of a vehicle, are to spread the load over more wheels, but their purpose is the same as vehicles with only one rear axle with only one wheel on each end of the axle. Even when there are tandem axles at the rear of a vehicle, there are only two dampers shared by both axles.

Current dampers that are used on the majority of vehicles are self contained and are of the hydraulic, telescopic variety where a piston that is attached to a rod slides inside a cylinder as described in U.S. Pat. Nos. 2,668,604 and 3,584,712. As the hydraulic liquid flows (caused by the motion of the rod and piston inside a pressure cylinder) through valves, a damping force is developed in both the extension and compression directions that extracts energy from the relative motion between the sprung and un-sprung masses. A volume of liquid necessary to compensate for the rod volume as the rod is extracted and reinserted into the damper, is stored in an annular space formed by an outer, reservoir tube that surrounds the pressure tube. The nature of this design produces one mathematical curve that relates the force developed as a function of piston velocity. This curve is optimized for normal driving, absorbing energy from the relatively high speed motion of the suspension and limiting the energy transmitted to the chassis.

A problem with current vehicles, especially recreational vehicles (RVs) that are mobile homes, has to do with leveling the chassis when parked. Recreational vehicles are vehicles that are usually derived from a truck, van or bus that has a living quarters built into the chassis. However, they can be custom built, from the ground up, as recreational vehicles, such as the GMC motor homes built from 1973 to 1978. Often the ground on which the RV is parked is not level so that the interior of the unit slopes with respect to the gravity field. There are two axes of interest for the chassis. One is lateral or left-to-right and the other is axial or fore-to-aft. Both need to be leveled. The out-of-level condition can be corrected by a variety of means that are currently in use. One such means is the addition of hydraulic leveling jacks at the four corners of the RV such as is disclosed in U.S. Pat. Nos. 5,913,525 and 5,188,379. These jacks extend from the chassis to the ground and lift the low corners up, thereby changing the angle between the chassis or sprung mass and the ground. Since the jacks are stiff, the chassis becomes fixed in place and the suspension is not allowed to move. However, these jacks have a couple of major disadvantages, the first being that they add significant weight to the RV which decreases the gas mileage. Second, they are relatively expensive, costing several thousands of dollars. Third, the foot that contacts the ground can settle if the ground is damp or structurally soft. A simpler method of leveling an RV is to use tapered or stepped blocks that are placed in front of the tires that are near the lower corners, then the RV is driven up onto them. There are patents on devices that attempt to minimize the effort of attaining the correct height such as U.S. Pat. No. 6,644,628 and U.S. Pat. No. 4,877,211. However, no matter what the exact shape of the ramps, the process is rather cumbersome and usually requires two or three attempts of adding or removing blocks to get the unit level enough. A variable height system is disclosed in U.S. Pat. No. 6,082,743 where an inflatable device is placed under the low tire which is then raised by air pressure. However, with these methods, even when the unit is level enough, the suspension is still in full effect, allowing the chassis to move with respect to the fixed suspension. As one moves around inside the RV, the change in the center of gravity of the unit causes the entire RV to rock. Wind gusts also produce significant loads on the large surface area of an RV, causing it to rock. These motions are relatively small but are, at the minimum annoying and when performing some cooking function, like pouring liquid, they can be quite aggravating if they cause liquid to be spilled.

There have been dynamic leveling devices that attach between the chassis and the axle that keep the distance between the axle and the chassis constant as the load on the chassis is changed. One such device is the self-pumping damper that uses the energy of the motion of the suspension to drive a pump that produces lifting forces as described in U.S. Pat. No. 3,836,132. The device of the '132 patent only maintains the average distance between the sprung and un-sprung masses. It does not maintain level with respect to the gravity field. There is also a dynamic assist unit described in U.S. Pat. No. 4,274,643 that uses air pressure or vacuum to keep a moving chassis at the same, average height above the axle. However, these devices do not lock the suspension from moving. Neither do they level the chassis with respect to the gravity field. These devices only adjust the distance between the chassis and the axle to be, on the average, a constant value as the load is changed. They are not true leveling devices, but rather, devices that maintain constant, average distance between the sprung and un-sprung mass. If the un-sprung mass is out of level, by say being parked on a hill, these devices force the chassis to also be out of level.

U.S. Pat. No. 4,145,073 discloses one method of locking the suspension and preventing an axle from moving with respect to the chassis. However, this device is separate from the normal suspension and is a cylinder that only locks the suspension at whatever distance it happens to be when the lock is engaged. There is no pressurized liquid involved as the locking cylinder is filled by gravity flow from a reservoir. The locking forces are produced by sealing the piston inside the cylinder and by trapping fluid on either side of the piston. The locking force is attained by a pressure drop across the piston. Because the locking is attained by blocking the flow from the piston, there are necessarily two ports on the cylinder through which liquid must flow. There is no way to change the distance between the axle and chassis after the lock is engaged and no mention of leveling. None of the prior art devices or systems that are integral with the suspension have addressed the problem of damping while travelling and leveling while parked in a single automated system for mobile vehicles such as Recreational Vehicles. The problem of providing a solution that is both functional and cost-effective still exists.

### SUMMARY OF THE INVENTION

This invention is directed to an improvement in the function of dampers used on mobile vehicles in need of temporary leveling such as recreational vehicles. The main function of current dampers (sometimes called shock absorbers) is to extract energy from the suspension system of a moving vehicle by forcing liquid through a system of valves internal to the damper. This invention adds two more functions. The first additional function is to level the chassis of the vehicle with respect to the gravity field. The second is to lock the suspension so it cannot move when the vehicle is stationary.

In accordance with the embodiments of the invention, the problem of providing a dynamic suspension when moving and then leveling and locking the suspension when stationary is addressed by providing a multi-function suspension system that acts in a first mode to damp road-induced motion, then when the vehicle is stationary levels the vehicle with respect to the gravity field, and finally locks the configuration to provide a stable living environment. The multifunction suspension system operates in three modes: travelling, leveling and locked. In the travelling mode the suspension acts as a motion damper in a similar manner to conventional shock-absorbers. In the leveling mode the suspension system acts to detect the gravity field, calculates axial and lateral angles of the vehicle, and then raises the corners to level the vehicle automatically. Finally, the system functions to lock the level configuration while stationary.

Embodiments of the invention are directed to apparatus for automatically leveling a wheeled vehicle having a plurality of axles comprising at least three single-port hydraulic cylinders positioned so as to define a plane of a chassis of said vehicle; an automated leveling system comprising electronic logic means for implementing Level, Lock and Travel modes, and a control manifold having electronically-actuated control valving controlling hydraulic fluid flow for each single-port hydraulic cylinder, and a mode selector valve for selecting between the Travel and Lock modes, said control manifold being in electronic communication with said electronic logic means; an accumulator in hydraulic communication with said control manifold; a hydraulic pump in hydraulic communication with said control manifold, said hydraulic pump being in electronic communication with said electronic logic means; and hydraulic lines that interconnect the previous hydraulic elements.

Other embodiments of the invention are directed to the prior apparatus wherein the single-port hydraulic cylinder is configured to leak across the piston contained within the single-port hydraulic cylinder; the electronic logic means is contained in a PCB that is attached to the chassis of the vehicle; and the electronically-actuated control valving comprises two normally-open pressure-to-close pilot-operated check valves, a leveling valve, and a pressure-to-open pilot-operated check valve for each single-port hydraulic cylinder. Another embodiment of the apparatus includes a compressive damping circuit in fluid communication with and located between each single-port hydraulic cylinder and the accumulator. The electronic logic means whereby one embodiment of the invention operates is disclosed in a logic tree comprising the logic diagram of FIGS. 12A-12C inclusive.

Other embodiments of the invention are directed to the previous apparatus wherein the PCB comprises one or more accelerometers having the capability of monitoring the x, y and z-axes either separately or individually. A related embodiment includes a method of safeguarding the operation of the vehicle comprising monitoring the signal of all three axes of said one or more accelerometers; and preventing the vehicle from entering the Lock/Level mode when any one of the three signals exceeds the noise level of the one or more accelerometers, which would indicate the vehicle is underway (an unsafe condition for the Lock/Level mode).

Another embodiment of the invention is directed to the previous apparatus further comprising a high pressure liquid subsystem in hydraulic communication with the control manifold. A particular embodiment of the subsystem comprises an air compressor, a storage tank, a pressure transducer, a two way, normally closed solenoid, an actuated air valve, and an air driven intensifier.

Another embodiment of the invention is directed to a manually-operated apparatus for leveling a wheeled vehicle having a plurality of axles comprising at least three single-port hydraulic cylinders positioned so as to define a plane of a chassis of said vehicle; a manual leveling system comprising a Lock/Travel valve and a Leveling valve for each single-port hydraulic cylinder; an accumulator in hydraulic communication with said manual leveling system; a hydraulic pump in hydraulic communication with said manual leveling system; and hydraulic lines that interconnect the previous hydraulic elements. The manually-operated apparatus may also include single-port hydraulic cylinders that are configured to leak across the piston contained within each cylinder; each Lock/Travel valve and Level valve are configured to be manually operable; and each single-port hydraulic cylinder has associated with it a large, leak proof, two way valve (Lock/Travel), and a small, leak proof, two way valve (Level). In yet another embodiment of the manually-operated apparatus the valves may be ball valves.

Yet other embodiments of the manually-operated apparatus may have a compressive damping circuit in fluid communication with and located between each cylinder and the accumulator; and in another embodiment a high pressure liquid subsystem in hydraulic communication with said manual leveling system. The high pressure liquid subsystem may comprise an air compressor, a storage tank, a pressure transducer, a two way, normally closed solenoid, an actuated air valve, and an air driven intensifier.

Another embodiment of the invention is directed to an apparatus for automatically leveling a wheeled vehicle having a plurality of axles comprising at least three single-port hydraulic cylinders positioned so as to define a plane of a chassis of said vehicle; an automated leveling system comprising electronic logic means for implementing Level, Lock and Travel modes, said electronic logic means contained in a PCB that is attached to said chassis of said vehicle, said PCB comprising one or more accelerometers having the capability of monitoring the x, y and z-axes either separately or individually; a control manifold having electronically-actuated control valving controlling hydraulic fluid flow for each single-port hydraulic cylinder, and a mode selector valve for selecting between the Travel and Lock modes, said control manifold being in electronic communication with said electronic logic means; an accumulator in hydraulic communication with said control manifold; a hydraulic pump in hydraulic communication with said control manifold, said hydraulic pump being in electronic communication with said electronic logic means; a high pressure liquid subsystem in hydraulic communication with said control manifold; and hydraulic lines that interconnect the previous hydraulic elements.

### BRIEF DESCRIPTION OF THE DRAWINGS

FIG. 1 is a schematic of the suspension system for one axle of a vehicle.

FIG. 2 is a schematic of the hydraulic system.

FIG. 3 is an outline sketch of a single port hydraulic cylinder that takes the place of the original equipment damper for the vehicle.

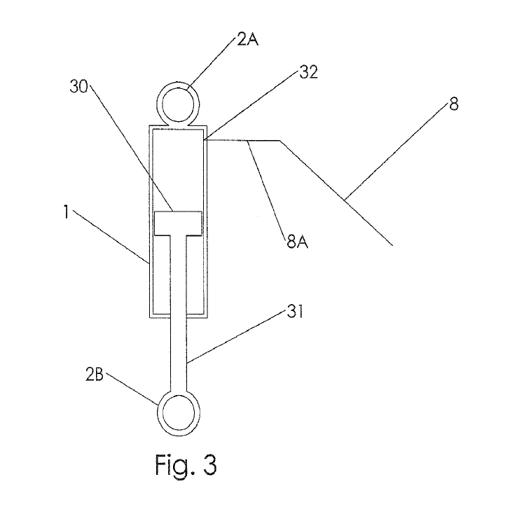

FIG. 4 is an isometric drawing of the valve that makes the system operate safely. It is a pressure-to-close, pilot operated check valve, 53.

FIG. 5 is a side view of this same valve showing the sectional indicators A-A.

FIG. 6 is a sectional view of the valve shown in FIG. 5 along the indicators A-A while the valve is in the open position as used in the travel mode.

FIG. 7 is a blow-up of the detail of FIG. 6 indicated as the circled portion “7”.

FIG. 8 is a blow-up of the detail of FIG. 6 indicated as the circled portion “8”.

FIG. 9 is another cross-section of FIG. 5 taken along A-A, only with the valve in its closed position as used when the suspension is locked and level.

FIG. 10 is a simplified version of the hydraulic schematic that is shown in FIG. 2. FIG. 10 shows only one cylinder and its associated valves.

FIG. 11 shows a PCB that contains the two major logic components.

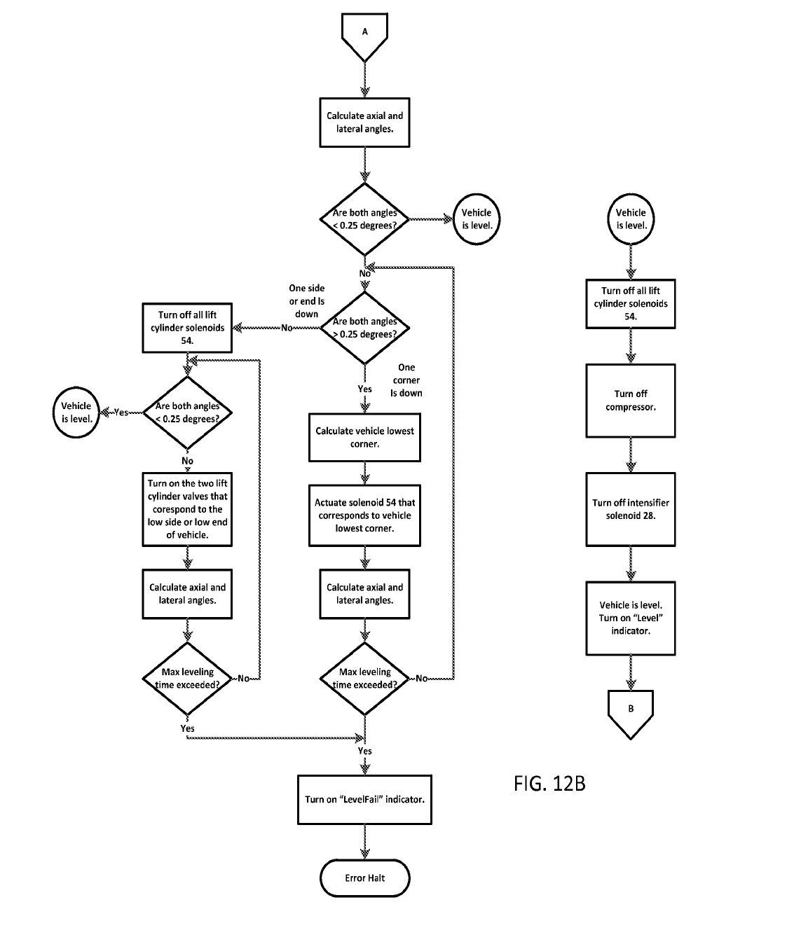

FIGS. 12A-12C is a logic diagram for software that changes from travel mode to auto level mode and then back to travel mode.

FIG. 13 is an exploded view of the valve of FIG. 6.

FIG. 14 is a schematic of a manual system, where the valves are manually actuated to change from Travel to Lock mode and to add pressurized fluid to the dampers.

### DETAILED DESCRIPTION OF EMBODIMENTS OF THE INVENTION

The invention is directed to a system and method for automatically or manually leveling the chassis of a vehicle such as a recreational vehicle that may be positioned on uneven ground. The leveling function may be provided by either three single-port hydraulic cylinders positioned so as to define a plane of a chassis of said vehicle, or a set of four single-port hydraulic cylinders (one per wheel in a standard two-axle/four wheel configuration); and a hydraulic control manifold that mimics dampers (shock absorbers) when the vehicle is traveling, but when parked, locks the suspension and changes the height of each corner of the vehicle to level the chassis. The three-cylinder or four-cylinder embodiments will function equally well, however, for purposes of illustration, the four-cylinder/four wheel embodiment is provided herein for purposes of illustrating the general concept of the invention.

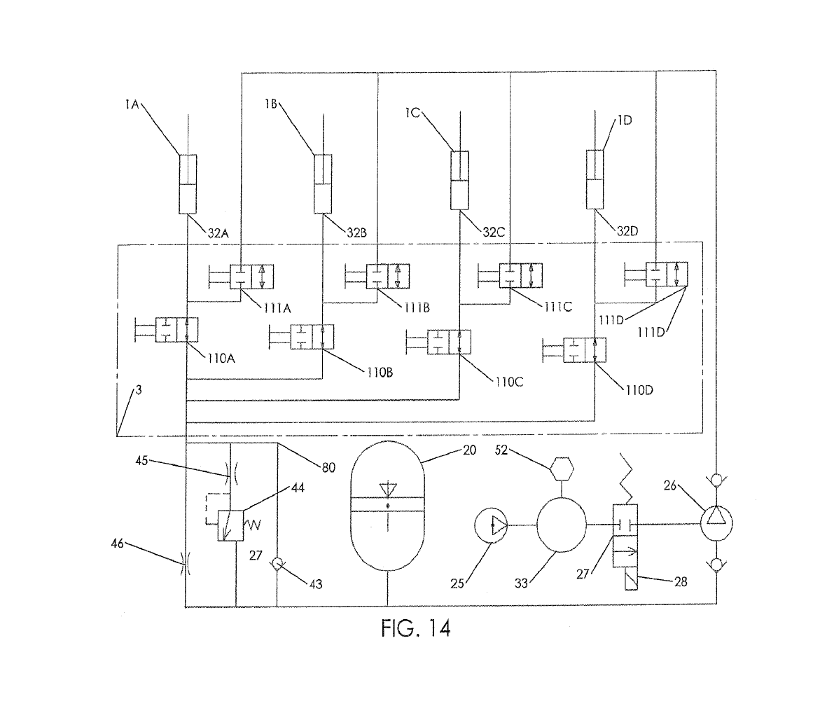

In a purely manual embodiment, all the logic to determine the two states is performed by the operator in selecting the position of the eight valves, 110A through 110D and 111A through 111D shown in FIG. 14. All eight valves are contained on the manual control manifold, 3.

In an automatic embodiment, the operator changes between these two states by the actuation of one two-position switch that has, in one embodiment, the indications “Travel” and “Level”. Other embodiments of the invention are applicable to vehicles with tandem rear axles with dual wheels even though for simplicity and purposes of illustration, the following disclosure will only discuss vehicles with one rear axle. A device that is referenced to a wheel can mean a device that is referenced to dual wheels on a tandem axle.

This invention is best understood by reference to the Figures. A listing of parts and their associated numbers is given at the end of this description for guidance only. All schematics use conventional pictographic elements that one of ordinary skill in the hydraulic arts would recognize and understand as having one definitive meaning. The logic tree similarly conveys to one of ordinary skill in the programming arts all of the steps necessary to operate the automated version of this leveling system.

The system that constitutes this invention has three major functions. The first is to provide damping forces when driving over a road in a similar fashion to shock-absorbing systems (“Travel” mode). The second is to provide locking forces for when the vehicle is static and being used as living quarters so that the vehicle does not rock and sway as its occupants move about or the outside is buffeted by winds (“Lock” mode). The third is to provide a leveling function to make the vehicle level with respect to the gravity field when the vehicle is static (“Level” mode). The “Lock” and “Level” functions can be done with manual actuation of switches or even direct, manual actuation of valves, but in the preferred embodiment, both functions are combined in the logic of the control circuit so that, as far as the operator is concerned, it appears automatic. The operator only chooses, by the selection switch, to be in the Travel mode or the Level mode. The locking function is invisible to the operator and happens automatically when the control switch is actuated to the Level state. The system also provides an automatic mechanism to transition back to the travel mode by flipping the switch back to “Travel”. The system is designed so that when it is put into the Travel mode, its valves are in their normal, un-actuated state, held there by their springs or detents. No power of any kind is required to maintain either the Travel mode or the Level mode.

The majority of the following teachings will be directed to the four-cylinder embodiment, except where specifically indicated otherwise. The overall system of this invention consists of seven sub-systems. One sub-system consists of the four, single port, hydraulic cylinders, 1, that replace the original equipment dampers/shock absorbers. A second sub-system is the control manifold that contains the electronically-actuated control valves for locking and leveling that can be either manually controlled or controlled by the logic control sub-system. A third sub-system is the source of high pressure liquid that is used to operate the pilot pistons of the pilot operated check valves and used to add high pressure liquid to the hydraulic cylinders 1. A fourth sub-system is an accumulator that pressurizes the entire system to about 200 psi in a preferred embodiment. The accumulator's main purpose is to drive liquid back into the hydraulic cylinders, 1, on the recoil stroke, that is, when the rod, 31, is being withdrawn from the hydraulic cylinder, 1. The fifth sub-system is the compressive damping circuit, 80, that produces compression damping as the rod, 31, is being inserted into the hydraulic cylinder, 1. The sixth is the electrical/logic/control sub-system which consists of the PCB, switches, solenoids and associated cabling. This sixth sub-system can be eliminated in a purely manually activated system. The final sub-system is the tubing and hoses that connect all the hydraulic sub-systems together.

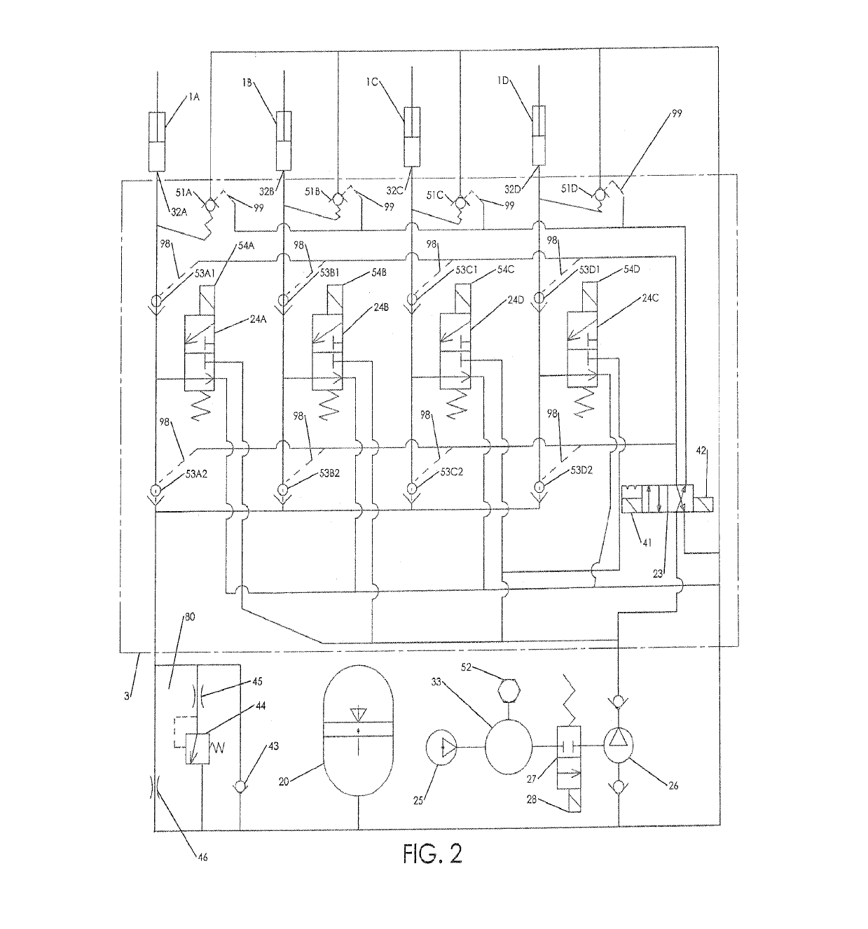

The source of high pressure liquid sub-system could be any high pressure hydraulic pump that can run off of the 12 volt DC power that is typically available in RVs. In a preferred embodiment and with attention directed to FIG. 2, the high pressure liquid subsystem comprises an air compressor, 25, a storage tank, 33, a pressure transducer, 52, a two way, normally closed, solenoid, 28, actuated air valve, 27, and an air driven intensifier, 26. The intensifier has an area ratio of about 70:1, so it will produce about 5000 psi of liquid from a 100 psi source of air when friction is taken into account. One or more of these components can be combined with the others to decrease the number of discrete parts, but their functions will remain and come within the scope of this invention.

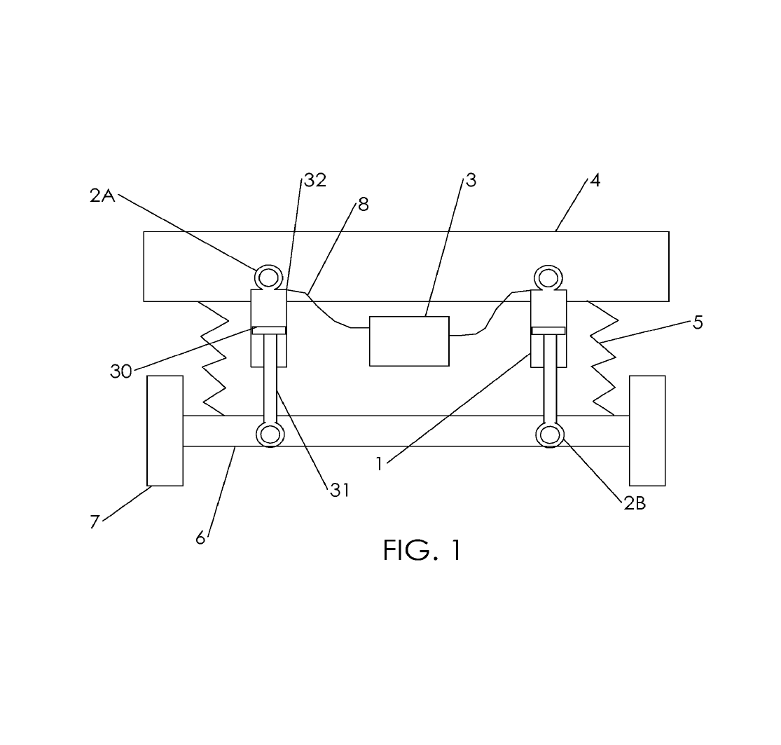

FIG. 1 is a schematic of the suspension system for one axle of a vehicle. The chassis, 4, which carries the passengers, is known as the sprung mass because it is supported by the springs, 5. The wheels 7, axle 6, a portion of the mass of the springs and a portion of any locating arms, not shown, are the un-sprung mass. This invention replaces the standard dampers used on vehicles with hydraulic cylinders 1, that have relatively large rods 31. In static mode, when the vehicle is parked and being used as living quarters, a portion of the load that is normally absorbed by the springs in the suspension system is taken by hydraulic pressure acting on the rod area. The pistons, 30, have a small built in leakage, so that there is no pressure drop across them in the static condition. The rods are large enough so that hydraulic pressures that are typical of industrial hydraulic systems can support a substantial portion of the vehicle's weight. In a preferred embodiment, the rod, 31, will be 1.125″ in diameter. This value produces a lifting area, due to rod area, of one square inch. In this embodiment, the maximum hydraulic pressure would be about 5000 psi, so each damper would be able to absorb 5000 pounds of static weight from the springs, 5, of the normal suspension. Since the nominal spring rate of the springs on a typical motor home is about 1200 pounds per inch, each damper can lift the chassis about four inches when its cylinder is pressurized to 5000 psi. Given these teachings, one of ordinary skill will be able to adapt these values to other situations for larger and smaller applications.

In FIG. 1, the wheels 7, are shown attached to the ends of an axle, 6. However, this is not meant to be restrictive to only vehicles with solid axles. This invention can be applied to any suspension system, such as un-equal “A” arms, McPhearson struts or any other system used to suspend a chassis by means of springs and dampers over the un-sprung mass. The cylinders, 1, are inserted between the axle, 6, and the chassis, 4, with the rod, 31, down. That is, the rod is attached to the axle, 6, and the cylinder attached to the chassis, 4, by the same means that the current telescopic, hydraulic dampers are attached. These attachment points are often eye rings, 2A and 2B, that are shown attached to the cylinder, 1, and to the rod, 31, respectively. However, this invention works just as well with other types of attachment methods such as studs that are coaxial with the damper or any other means that a vehicle manufacturer might use to attach dampers. In the preferred embodiment, the inner diameter of the cylinder, 1, is 1.625 inch, which produces an annular area between the rod and the cylinder of 1.08 square inches. The outer diameter of the cylinder is two inches which produces a wall thickness of 0.188 inch. The hydraulic cylinder, 1, and its rod, 31, are made of steel in a manner similar to commercial hydraulic cylinders. Typically the rod, 31, is made of hardened carbon steel and plated with hard chrome. Larger rods and cylinders could be used to produce even more lifting force. Rods, 31, can be protected from atmospheric dust and dirt by an elastomeric boot, not shown.

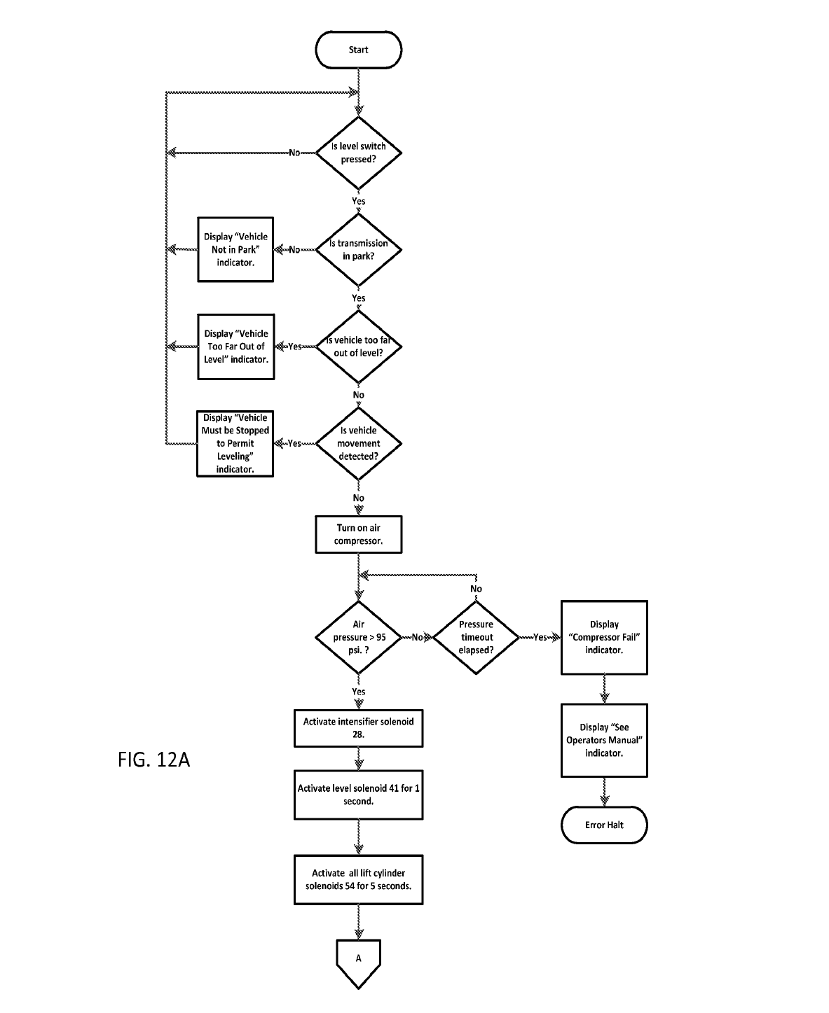

FIG. 2 is a schematic of the automatic hydraulic system. Note that since there are four wheels in this embodiment, there are four cylinders and four sets of valves that control the leveling function. These duplicated components have the same number in FIG. 2, but vary by the letters A through D. FIG. 10 is a simplified version of FIG. 2, that shows only one cylinder, 1, making it easier to follow the liquid flow and logic of leveling and damping. All the valves associated with locking and leveling are contained in or on the control manifold, 3.

As previously mentioned this system may be designed with only three hydraulic cylinders. This is so because it takes a minimum of three points to define a plane, and since the chassis of a vehicle defines in one aspect a plane that roughly approaches the horizontal plane, a three-cylinder configuration could also be used instead of the four-cylinder/one per wheel embodiment previously disclosed. Thus, a three-cylinder configuration is the minimum number of hydraulic cylinders needed to effect the functions described herein. Therefore, the hydraulic cylinders would be positioned so as to define a plane of a chassis of the vehicle. To effect the capability of adjusting the floor of the RV to the horizontal plane with the minimum of three hydraulic cylinders, the cylinders should be affixed to the chassis at points that allow them, acting in concert, to level (with respect to the horizon) the interior floor of the RV with respect to the gravity field. Those points will be a function of the effective range of motion of the pistons and the actual mounting point of the hardware on the chassis. One of ordinary skill is able to ascertain these points in designing a three-cylinder leveling system.

An embodiment of the automated control manifold has electronically-actuated control valving (a solenoid valve or its equivalent) controlling hydraulic fluid flow for each single-port hydraulic cylinder, and a mode selector valve for selecting between the Travel and Lock modes, the control manifold being in electronic communication with the electronic logic means. Whether the system is in travel mode or locked mode is determined by the four-way mode selector valve, 23, which, in a preferred embodiment, is model number VSD03M-3A-GB-60L made by Continental Hydraulics of Minneapolis, Minn. This mode selector valve switches the pilot pressure of the pilot operated check valves to either intensifier pressure or accumulator pressure. In order to shift the pilot operated check valves, 53, there must be intensifier pressure which requires that the air compressor, 25, be on, producing pressure and that the air valve, 27, has its solenoid 28 activated. This will activate the intensifier, 26, and allow the four-way mode selector valve, 23, to select travel mode by activating travel solenoid 42 or locked mode by activating level solenoid 41. The mode selector valve, 23, has two positions that are both detented. That is, when their respective solenoid is activated, the valve shifts and is held in that position after the power to the solenoid is shut off. For the travel mode, travel solenoid 42 is activated for a short time, say one second. This shifts the valve to apply accumulator pressure to all eight pilot port lines, 98, of the eight pressure-to-close, pilot operated check valves, 53, and to apply intensifier pressure to all four pilot lines, 99, of the four pressure-to-open, pilot operated check valves, 51A-D. Power is then removed from travel solenoid 42, but the four-way mode selector valve 23 remains in the same position, allowing the free flow of liquid through the damping circuit including both, open pressure-to-close, pilot operated check valves, 53, for each cylinder, 1.

The first function is to provide essentially the same damping forces that the original equipment dampers provided while the system is in the travel mode. This is accomplished on the recoil stroke of the cylinders, 1, by valving in the piston, 30, that mimics that of the original dampers. There is essentially no difference between the kinds of recoil valves used in this invention and those used on the original equipment dampers. However, on the compression stroke, there are no valves in the cylinders, 1, nor in the pistons, 30, to provide compression control. Compression control is provided outside the cylinders, 1, by liquid flowing out of the cylinder, 1, through port 32 into a short section of flexible tubing, 8A, then into fixed, steel tubing, 8, through the control manifold, 3, that contains the open, pressure-to-close pilot operated check valves, 53, then on to the compression damping circuit, 80. This system of valves consists of the three-stage damping valves, 44, 45 & 46 that, along with check valve, 43, are collectively known as the compressive damping circuit, 80. These damping valves are the same kind as used in currently available dampers and typically consist of a blow off valve, 44, that is in parallel with a small restriction, 46 that is used for low speed control and in series with a large restrictor, 45, which is for high speed control. From the damping valves, the liquid flows into the accumulator, 20. The gas pressure in the accumulator provides the motive force to return the liquid back to the cylinder, 1, during the recoil stroke. There is a check valve, 43, that is in parallel with the compressive damping circuit 80 that allows liquid to flow back into the cylinder, 1, from the accumulator, 20, on the recoil stroke. There is need for a short section of flexible tubing to connect the port, 32, to compensate for small rotations of the cylinder, 1, as the suspension moves.

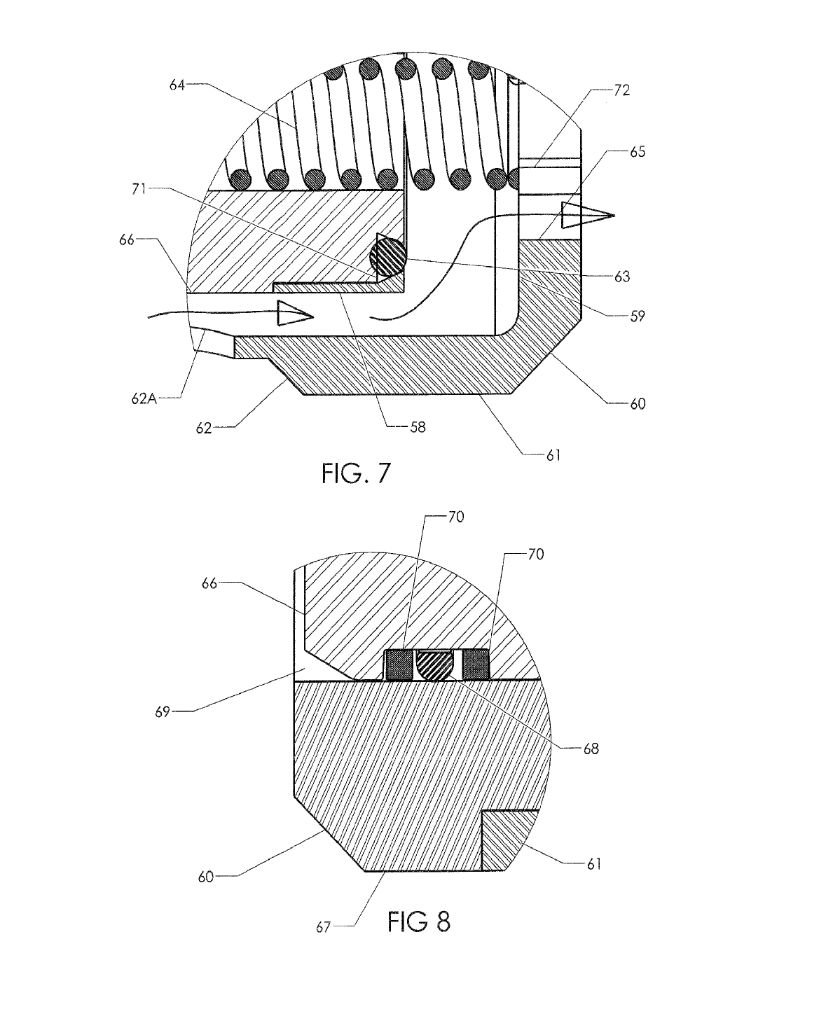

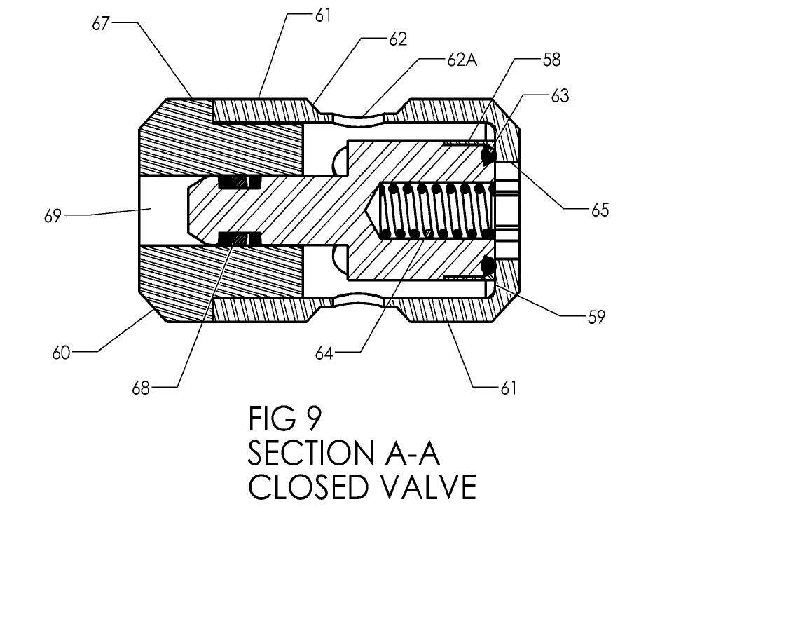

An important feature of the free flow path for damping, is the open, pressure-to-close, pilot operated check valves, 53. They are normally open, held that way by their springs, 64. For each cylinder, 1, there are two pressure-to-close, pilot operated check valves, 53, in series for each cylinder, 1. When in the travel mode, liquid flows out of the cylinder, 1, on the compression stroke, through the port 32 into the tubing, 8, to the control manifold 3, that contains the pressure-to-close pilot operated check valves, 53. Liquid flows into the pressure-to-close, pilot operated check valves, 53, through the annular cut, 62, and related port holes, 62A, into the interior of the valve, 53, as shown by the flow arrows in FIG. 6. The liquid then flows around the corner of the piston, 66, and out through the exit port, 65, as shown in FIGS. 6 and 7. Liquid flowing out of the first pilot operated check valve, 53, then flows to the annular cut, 62, of the second pilot operated check valve and out through its exit port, 65, to the compressive damping circuit 80 and finally to the accumulator, 20. On the recoil stroke of the cylinder, 1, liquid flow is reversed, coming out of the accumulator, 20, through the check valve, 43, through the two open, pressure-to-close, pilot operated check valves, 53, back to the cylinder, 1, by way of the tubing, 8, and port 32. Having the pressure-to-close, pilot operated check valves, 53, normally open is an important safety factor in that it is imperative to not lock the suspension while traveling. These valves are open without pressure to their pilot port, 69, as that is their normal state, being held open by their internal spring, 64. A simpler circuit could be designed using only one normally closed, pressure-to-open, pilot-operated-check valve, but that would require continuous pressure to be applied to the pilot port to maintain an open circuit for the liquid to flow in and out of the hydraulic cylinder, 1, while the system is in the travel mode. This would be a dangerous condition, as any failure to maintain pilot pressure would cause the suspension to lock up, which could cause loss of control of the moving vehicle.

Although pressure-to-open, pilot operated check valves are commercially available, pressure-to-close pilot operated check valves, 53, are not readily available. For a preferred embodiment of this valve, the outer diameter of the housings, 61 and 67, is one inch and the entire valve, 53, is 1.90″ long. Each end of the cylindrical pilot operated check valve, 53, is chamfered at 45° to mate to a standard O-ring for sealing which would be a standard −118 size. The piston, 66, is stepped with a larger diameter of 0.625″ that contains the sealing O-ring, 63, and a smaller, pilot diameter that is 0.311″ in diameter that contains the pilot sealing O-ring, 68. The annular flow area around the piston, 66, is 0.18 square inches, while the exit port, 65, is 0.20 square inches. For a flow of 30 cubic inches per second, which is a typical maximum expected from a rod, 31, of one square inch area, these areas produce a maximum flow velocity of about 12 feet per second, which is a reasonable number for liquid flow through valves. The exit port, 65, has fingers, 72, that extend toward the center of the port from its outer diameter. These fingers provide a stop for the spring, 64, to push against. The spring, 64, has a force of 12 pounds when collapsed and its purpose is to urge the piston, 66, into an open position as shown in FIG. 6. It is this open position that is used for the travel mode.

In the travel mode, when the cylinder is acting as a damper, it is necessary for the liquid to freely flow in and out of the port, 32, while all valves are in their normal condition, that is, in the condition that their springs urge them. No electrical, pneumatic or hydraulic pilot pressure is needed to maintain this normal condition. This is necessary for safety reasons as the other condition of the system is for the cylinders to be locked. It is not allowable that the system could become locked while moving as that would cause the suspension to be locked which could cause loss of control of the vehicle. A very desirable condition is for the system to be passive in the travel mode, not requiring any signal or active control to maintain free flow of liquid through the port 32 of the damper.

Liquid is automatically forced out of the cylinder, 1, during the compression stroke through port 32 as the rod, 31, is forced into the internal volume of the cylinder, 1. On the extension stroke, the interior volume of the cylinder increases as the rod, 31, is extracted. To fill this volume, the liquid exterior to the port, 32, must be under some pressure to cause it to flow into the void formed by the retracting rod. This is accomplished by having this exterior volume of liquid pressurized at all times by an accumulator, 20. In a preferred embodiment, the accumulator consists of a steel tank that has an elastomeric bladder separating the compressed nitrogen and the hydraulic liquid used in the damping system. In a preferred embodiment, the accumulator is part number EBR20-60 1QT by Tobul Accumulator, Inc., of Bamberg, S.C. In a preferred embodiment, the accumulator is pressurized to about 200 psi by nitrogen. The entire hydraulic system is pressurized by the accumulator. When there is no motion and the pilot valves are open, the pressure is 200 psi everywhere. The constant pressure source of the accumulator, 20, is connected to the port, 32, by two, pressure-to-close, pilot operated check valves, 53, that allow free flow through the port, 32, to and from the accumulator, 20, when the valve, 53, is in its normally open position.

When the vehicle is parked and ready to be used as a stationary home, the operator flips the control switch from Travel to Level. This starts a sequence of operations. It is important that the vehicle is stationary before the cylinders are locked. There are two safety checks that are employed. First, they system checks that the transmission is engaged in Park. Second, the system checks that both axes of the dual axis accelerometer are quiet. If the vehicle is moving down the road, the chassis will be accelerating slightly, causing the accelerometers to produce a changing output. This accelerometer output can be used to infer that the vehicle is moving. Each accelerometer has some noise level in its signal due to thermal noise, radio noise, etc. A real change in angle should be several times this noise level so that it is statistically significant. A precision accelerometer is chosen so its error sensitivity is small enough so the vibrations of driving will produce a clear, statistically significant signal. Only when the accelerometer is quiet, that is, producing a signal statistically indicative of a Parked condition, will the suspension be locked.

The cylinders are locked by shifting the four-way valve 23 by activating travel solenoid 42. In order to shift the pilot pressure, there must be intensifier pressure which requires that the air compressor, 25, be on, producing pressure and that the air valve, 27, has its solenoid 28 activated. This will activate the intensifier, 26, and allow the four-way valve 23 to be selected to lock mode by activating level solenoid 41. The mode selector valve, 23, has two positions, that are both detented. That is, when their respective solenoid is activated, the valve shifts and is held in that position after the power to the solenoid is shut off. For the locked mode, level solenoid 41 is activated for a short time, say one second. This shifts the valve to apply intensifier pressure to all eight pilot port lines, 98, of the eight pressure-to-close, pilot operated check valves, 53, and to apply accumulator pressure to all four pilot lines, 99, of the four pressure-to-open, pilot operated check valves, 51. Power is then removed from level solenoid 41, but the four-way valve 23 remains in the same position, causing the fluid in each cylinder to be trapped. Then the system then pumps a little liquid into each cylinder by sequentially opening valves, 24, by actuating their solenoids, 54, so each cylinder, 1, has a pressure of at least 100 psi above the accumulator pressure. This additional pressure keeps the upstream pressure-to-close, pilot operated check valve, 53A1, closed, even when pilot pressure is removed from the pressure-to-close, pilot operated check valve, 53A1. All the cylinders then have pressurized liquid trapped in them, so the chassis cannot move. The system then checks level, determines which corner is low, then pumps liquid into the cylinder that's in the lowest corner. In order to lock the cylinders the pilot pressures must be shifted from the travel mode.

There is one leveling valve, 24, for each cylinder, 1. This valve can be model number VC08-3 from HydraForce, Inc. of Lincolnshire, Ill. Each leveling valve, 24, is a three way valve that has its output port connected to the line between the two pressure-to-close, pilot operated check valves, 53A1 and 53A2. Each leveling valve, 24, is actuated by a solenoid, 54. The two input ports are connected to accumulator pressure and intensifier pressure respectively. The normal connection is to accumulator pressure, that is, when there is no signal to the solenoid, 54, the valve's spring shifts the flow to the accumulator line and the intensifier line is blocked. When a signal is sent to the solenoid, 54, the valve, 24, shifts to connect the intensifier pressure to the output line between the two pressure-to-close, pilot operated check valves, 53, and the line to the accumulator is blocked. Since the pressure-to-close, pilot operated check valve, 53A2 is downstream from this connection, any pressure tends to close the check valve even more. The other pressure-to-close, pilot operated check valve, 53A1, is upstream, so if the pressure in the line is higher than the pressure in the cylinder, 1, the check valve will open and allow liquid to flow into the cylinder, 1, until the pressure in the cylinder equals that of the intensifier.

The system calculates which corner is lowest, then pumps liquid into that cylinder, 1, to make the un-sprung mass more level with the gravity field. This has the effect of changing the angle of the un-sprung mass with respect to the unlevel ground. The liquid is pumped by an air driven intensifier, 26, through the respective open valve, 24. The pressure-to-close, pilot operated check valve, 53, is a check valve, which means it blocks flow in the checked direction, but allows flow in the other direction. The high pressure fluid from the open valve, 24, forces the closed valve o-ring, 63, off of its sealing seat, 59, because the sealing area of the O-ring, 63, is larger than the pilot port 69 area. This procedure is performed first for the lowest corner of the vehicle and continued until at least one axis of the chassis is level. Then the next lowest corner is raised, if necessary, to level the other axis. This process is continued, pumping liquid into the cylinder in the lowest corner until the chassis is level along both axes.

To change from the Level mode to Travel mode, there must be pressure from the intensifier, 26, and the travel solenoid 42 on valve 23 must be activated. This switches accumulator pressure to the pilot port lines, 98, of the pressure-to-close, pilot operated check valves, 53, and connects intensifier pressure to the pilot lines, 99, of the pressure-to-open, pilot operated check valves, 51. This opens the pressure-to-open, pilot operated check valves, 51, thereby bleeding any excess pressure above accumulator pressure, out of the cylinders, 1. It also allows the internal springs, 64, of the pressure-to-close, pilot operated check valves, 53, to urge them open, thereby providing free flow of liquid through them. In a preferred embodiment, the pressure-to-open, pilot operated check valves, 51, can be part number 2741 from Kepner Products of Villa Park, Ill.

An embodiment of the invention is directed to an automated leveling system comprising electronic logic means for implementing Level, Lock and Travel modes; a control manifold having electronically-actuated control valving controlling hydraulic fluid flow for each single-port hydraulic cylinder, and a mode selector valve for selecting between the Travel and Lock modes, the control manifold being in electronic communication with said electronic logic means.

The electronic logic means comprises a printed circuit board (“PCB”) 100 that contains components that contain all the communication, memory and logic functionality necessary to automatically level the chassis when the “Level” switch is actuated. PCB 100 includes a processor 102 capable of carrying out routine scientific calculations. PCB 100 also includes an accelerometer 101 having at a minimum two axis capability for x- and y-axis leveling. In one embodiment accelerometer 100 is used in the Level mode and requires the signals from at least the x- and y-axes to be monitored and compared for purposes of carrying out the Level algorithm. In a second embodiment the accelerometer signals from all three axes are used to determine whether the vehicle is travelling or not. Alternatively, the traveling determination may be made on the basis of the output from the z-axis only, which is the axis associated with up-and-down, or bouncing, motion.

The actual calculation carried out by the electronic logic means of which corner of the chassis (that is, the portion of chassis that is over a wheel) is the lowest follows. Each axis of the accelerometer, 101, has an output that is a vector fraction of the normal gravity acceleration that can be designated by the symbol p. A vector fraction means that the output has both value and direction that is either positive or negative. The angle about an axis is calculated as the arcsin (ρ/g), where g is the acceleration of gravity and ρ/g is the vector fraction. By convention from the driver's seat, the angle about the lateral axis is a and, is positive when the left side is lower than the right. The angle around the longitudinal axis is β and is positive when the front is lower than the rear. The processor, 102, looks at both angles then makes a determination of which corner is lowest by comparing the sign of the angles. By convention, a zero angle is taken as positive. If both angles are positive, the front, left corner is lowest. If both are negative, the right, rear corner is lowest. If α is negative and β is positive, then the right, front corner is lowest. If α is positive and β is negative, then the left, rear corner is lowest. The PCB 100 is attached to a fixed position on the chassis, such as a wall. In one embodiment an accelerometer having at least x- and y-axes 101 is attached to the PCB, 100, that provides the signal used by the processor, 102, to determine which logic step to do next. In a preferred embodiment, a triple-axis accelerometer is used. One such accelerometer used in the current embodiment is model number BMA180 by Bosch Sensortec company, that can be found at the URL http://www.bosch-sensortec.com/content/language1/html/index.htm. Its sensitivity is 0.013°, so to determine if it is quiet, it is checked for three seconds and must not have a reading greater than 0.015°. The processor used can be model number PIC18F45J10 by Microchip Company of Chandler, Ariz. The PCB, 100, is fixedly attached to some rigid feature inside the chassis, such as a wall, that is readily accessible to the operator.

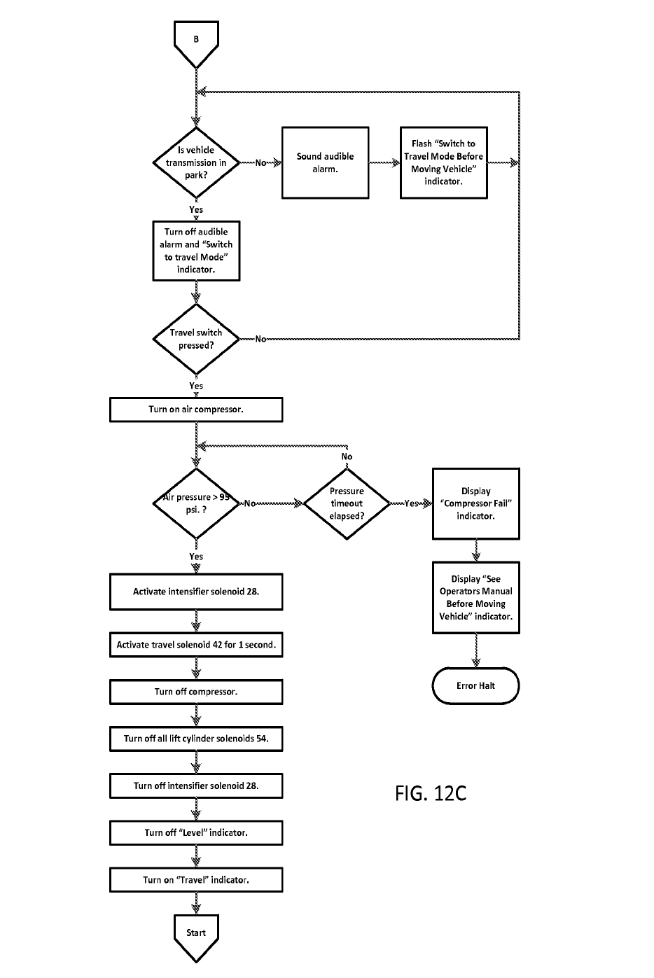

When the “Level” switch is activated, the logic circuit is initiated and starts the following sequence of events, which is also represented in more detail in the logic diagram, FIGS. 12A-C, which although comprising three separate figures is in actuality one logic diagram.

Beginning at FIG. 12A, the logic tree includes the following main steps/decision points. Diamond boxes indicate decision points while rectangles indicate sequential step functions.
1. If the “Level” switch is activated (depressed), then the leveling mode is active.
2. Checks whether the transmission is in “Park”. If no, stop and display “Vehicle not in Park”. If yes, proceed to leveling sequence.
3. Vehicle level check. In this embodiment, if the vehicle is more than three degrees out of level, then it cannot be automatically leveled and must be repositioned first.
4. Checks whether vehicle movement is detected by both axes of the accelerometer being quiet, that is, if their output is constant over a three second interval of time within a small error of say, 0.015°. If no, stop. If yes, proceed.
5. Activates power to the air compressor.
6. When the air pressure is at least 95 psi, it opens the air valve, 27, by activating solenoid, 28, which in turn powers intensifier, 26.
7. Activates level solenoid 41 on valve 23 to switch pilot pressure to the pilot ports of all the pressure-to-close, pilot operated check valves, 53, which locks all the cylinders, 1, by trapping their liquid inside. The switch also ports accumulator pressure to the pilot ports of the pressure-to-open, pilot operated check valves, 51, thereby making them closed. Level solenoid 41 can then be shut off and valve 23 will remain in the same condition because it is detented.
8. Activates all solenoids 54 of valves 24 for five seconds then shuts them off. This adds some liquid to each cylinder, 1, thereby increasing the pressure in each cylinder to 200 psi above the accumulator pressure which locks all the pressure-to-close, pilot operated check valves, 53, closed, even if pilot pressure is removed.
   FIG. 12B continues the logic sequence for the leveling function.
9. Using the level data from the two-axis accelerometer, the processor, 102, calculates the out-of-level angles both axially and laterally and from this, calculates the lowest corner.
10. Actuates the solenoid, 54, of the valve, 24 that corresponds to the lowest corner and continues to actuate while checking the chassis angles. The solenoid power is turned off when one angle is within 0.10° of level.
11. Reverts to step 5 unless both angles are less than 0.10°, in which case it shuts all systems down as the chassis is level and no power is needed to maintain this condition.

To switch from the Level mode to the Travel mode, the operator activates the 2-position switch to “Travel” which starts the following sequence of events, as shown in FIG. 12C.
1. Verify vehicle transmission is in Park. If No, then sound alarm, flash warning. If yes, proceed to next step.
2. If vehicle in Park, then turn off alarm and switch display to “Travel Mode” indication.
3. Determine if Travel switch depressed. If No, return to Step 1. If Yes, proceed to next step.
4. Activate power to the air compressor.
5. If air pressure does not get to 95 PSI within the timeout limit, then “Compressor Fail” is indicated and Error Halt results.
6. When the air pressure is at least 95 psi, it opens air valve 27 by activating the solenoid, 28, which in turn powers intensifier 26.
7. Activates travel solenoid 42 on valve 23 to switch pilot pressure to the pilot ports of all the pressure-to-open, pilot operated check valves, 51, which relieves all pressure in the cylinders, 1. It also ports accumulator pressure to the pilot port lines, 98, which connect to the pilot ports, 69, of all pressure-to-close, pilot operated check valves, 53, thereby allowing their internal springs, 64, to open them. This condition allows free flow through all the pressure-to-close, pilot operated check valves, 53. Level solenoid 41 can then be shut off and valve 23 will remain in the same condition because it is detented.
8. The system then shuts down, as no power is needed to maintain this condition.

In another embodiment all of these automatic functions could be accomplished by connecting manual switches to control the solenoids of the various valves, and such a manual system is within the skill of one of ordinary skill in the art. Alternately, a purely manual system could be built as shown schematically in FIG. 14. The manual embodiment is directed to an apparatus for leveling a wheeled vehicle having a plurality of axles comprising at least three single-port hydraulic cylinders positioned so as to define a plane of a chassis of said vehicle; a manual leveling system comprising a Lock/Travel valve and a Leveling valve for each single-port hydraulic cylinder; an accumulator in hydraulic communication with said manual leveling system; a hydraulic pump in hydraulic communication with said manual leveling system; and hydraulic lines that interconnect the previous hydraulic elements.

In this manual embodiment shown in reference to FIG. 14, one large, leak proof, two way valve, 110, is needed for each cylinder, 1, and is connected between the single port outlet, 32, and the compression damping circuit, 80. This large valve, 110, must be large enough to allow the flow induced by rod displacement. The large valves, 110, are left open for the travel mode and closed to lock the suspension. Each cylinder, 1, also needs a small, leak proof, two way valve, 111, that is attached to the line feeding the cylinder, 1, through the single port, 32, and to the output of the high pressure pump 26. These small valves are used to add fluid to the cylinders to extend them and level the respective corner. All eight valves are attached to the control manifold, 3. It is noted that this control manifold 3 is significantly different from the automated control manifold 3 of FIG. 2. A kind of commercially available, manually actuated, leak proof valve that can be used for this manual system is a quarter turn ball valve. Many models are available, but a model that is used for the small valve, 111, in the preferred embodiment of the manual system is model KHP-10 made by Hydac Company of Bethlehem, Pa. Their valve, KHP-16, can be used for the large valve, 110. The only extra device that would be needed for manual leveling would be a bubble level on the chassis to determine how far off of level the chassis is. However, a manual system would allow for many possible human errors, so the automatic system is greatly preferred.

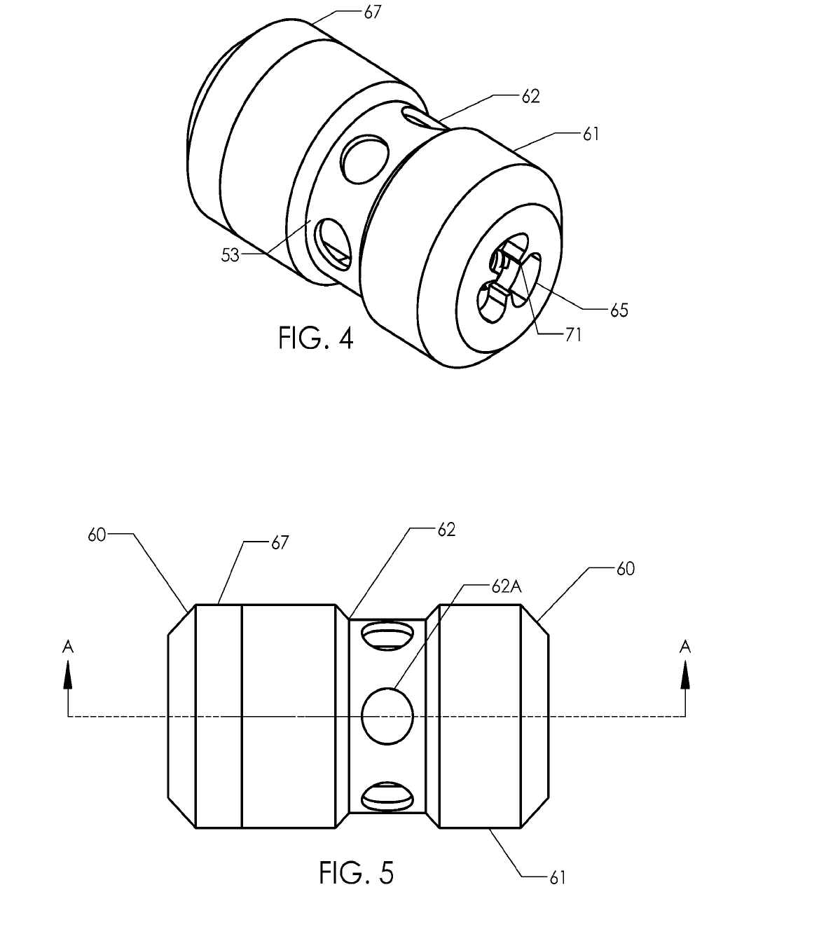

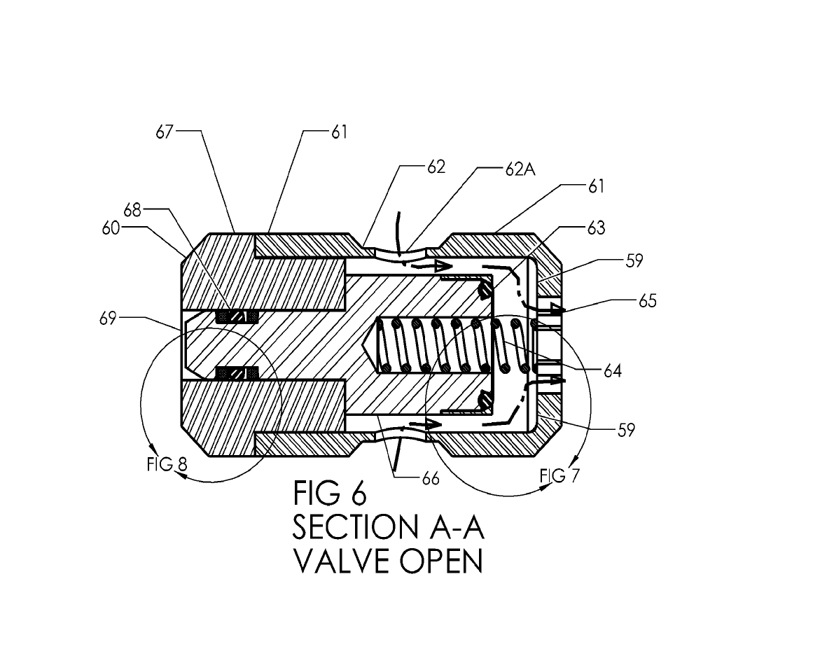

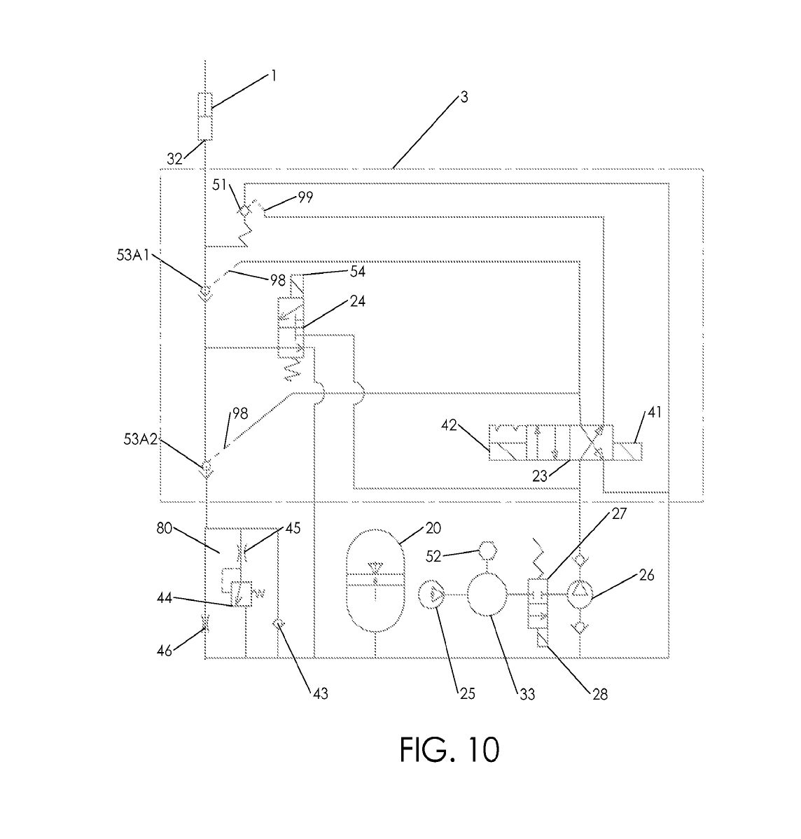

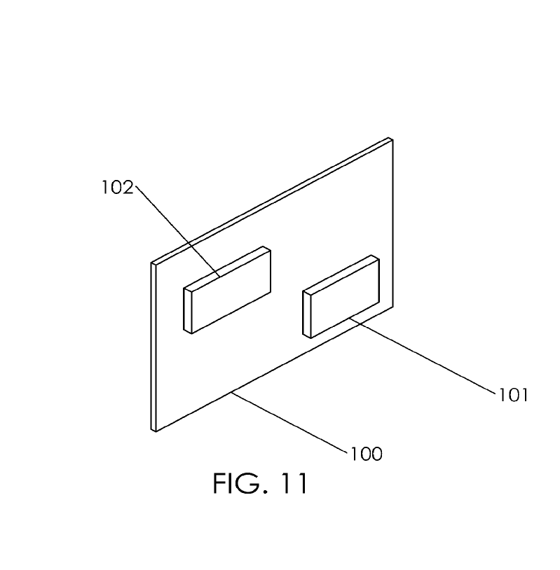

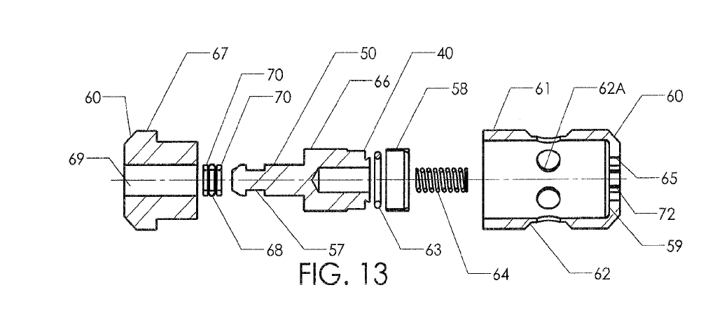

A novel valve in this invention is a very low leakage, pressure-to-close, pilot operated check valve, 53, of which two are required for each cylinder, 1. Since there are four cylinders, one for each wheel, there are four sets (total of 8) of pressure-to-close, pilot operated check valves, 53A1 through 53D2. The preferred embodiment of these pressure-to-close, pilot operated check valves, 53, is shown in FIGS. 4 and 5 and in the cross sections, FIGS. 6-8, which show the valve in its open position and in exploded view in FIG. 13. The circled details of FIG. 6 show the open valve blown-up in FIGS. 7 and 8, respectively. FIG. 9 shows the valve in its closed position. FIG. 13 shows a cross section of the valve in an exploded form. In a preferred embodiment the valve, 53, is generally cylindrical in shape and sealed into a cylindrical cavity (not shown) in the control manifold, 3, by two O-rings (not shown) that fit into a standard, triangular cross section, static crush space provided by chamfers, 60, on each end of the valve, 53. This type of seal is a standard seal for sealing high pressure liquids. The generally cylindrical shape of the valve, 53, is formed by two lathe machined housings, 67 and 61, that mate together and, in a preferred embodiment, have an outside diameter of one inch. During the travel mode when liquid is freely flowing to and from the cylinder, 1, the normal flow path is for liquid to flow from the cylinder, 1, through the tubing, 8, to the manifold, 3, that contains the valves, 53. In the manifold, liquid is plumbed into annular cut, 62, and its related port holes, 62A, and into the interior of the valve. The annular cut, 62, is a half inch wide and 0.035″ radial depth. The six radial port holes, 62A, are 0.25″ in diameter. During this free flow mode, accumulator pressure is ported to the pilot port, 69, while the piston, 66, is urged away from the sealing surface, 59, and outlet port, 65, by spring, 64. The liquid then flows toward and then out through the exit port, 65, as indicated by the flow arrows in FIGS. 6 and 7. When liquid is flowing into the cylinder, 1, on the extension stroke, the flow is simply reversed. When the valve is closed, the sealing area is between the O-ring, 63, and the inner, flat surface, 59, which is the inner sealing surface of the housing, 61. The O-ring, 63, is retained inside a dove-tail groove, 71, that is in the end of the piston, 66. The dovetail groove, 71, is designed for an O-ring, 63, that can be a standard part number −013. The dovetailed groove, 71, is formed from sleeve, 58, and a machined surface, 40, on piston, 66. The piston, 66, is urged to open by its spring, 64, which can be a spring with part number 70709 from Century Spring of Los Angeles, Calif. which produces a twelve pound force when in the installed condition. When the cylinders, 1, need to be locked, the valve, 53, is closed by adding pilot pressure to the pilot port, 69, which provides enough force to overcome the opening force of spring, 64. Pilot port, 69, in the preferred embodiment is 0.312″ in diameter and is sealed from the liquid inside the valve by a combination of the O-ring, 68, surrounded on both sides by the hard rubber backup seals, 70. These fit into groove, 57, which is machined into the small diameter, 50, of the piston, 66. The small diameter, 50, is 0.002″ in diameter less than the hole for the pilot port, 69. This sealing assembly is shown in detail in FIG. 8. It consists of an elastomeric, O-ring seal, 68, sourced from a multitude of vendors under the general designation of −008. There are two hard rubber back up rings, 70, that are on either side of the O-ring, 68. The backup rings can be part number Parback N1444-90 8-008. Both backup rings and the O-ring fit into the groove, 57, that is machined into the small diameter, 50, of the piston, 66.

Whenever there is more pressure in the cylinder than the 200 psi provided by the accumulator, the valve, 53, is held closed by this internal pressure acting on the annular area between the seal diameter of O-ring, 63, and the pilot diameter of the pilot port, 69. In the preferred embodiment, the inner diameter of the sealing O-ring, 63, is 0.440″, which has an area of 0.15 square inches. A pressure differential of 80 psi higher inside the valve, 53, than downstream of the exit port, 65, will overcome the twelve pounds of force exerted by the spring, 64, thereby keeping the piston, 66, securely forced against its sealing seat, 59, even when pilot pressure at the pilot port, 69, is reduced to the same accumulator pressure as is downstream of the exit port, 65.

The exit port 65, has fingers, 72, that protrude radially inward from the outer diameter of the outlet hole to retain the spring, 64, from exiting through the exit port 65. When the valve, 53, is closed by pressure on the pilot port, 69, liquid can still be added to the cylinder, 1, through the exit port, 65, by applying sufficient pressure because the sealing area of the O-ring, 63, is significantly larger than the area of the pilot port, 69. The pilot port, 69, has a diameter of 0.312″ and an area of 0.076 square inches so the annular area to open the valve is the difference or 0.074 square inch. In the preferred embodiment, the inner diameter of the sealing O-ring, 63, is 0.440″, which has an area of 0.15 square inches. Because the opening area is twice the closing area, liquid will always be able to pass through the pilot operated check valve, 53A1, toward the cylinder, 1, until the pressure in the cylinder, 1, equals the pilot pressure.

In the preferred embodiment, all pressure to run the pilot valves is developed by an air driven intensifier, 26, that in turn is powered by an air compressor, 25, that is run off of the 12VDC electrical system of the RV. This air compressor can be a model JH12TC by JAE Enterprises of Almo, Ky. This unit comprises several components, including the air compressor itself, 25, the tank, 33, and the pressure transducer, 52. The air compressor, 25, is in a running state whenever there is a need to change the state of valve 23. That is to change from travel mode to locked mode or from locked to travel mode. The air compressor charges a tank, 33, to 100 psi, then shuts off. The air output from the tank, 33, is connected to an air valve, 27, that is normally closed. Its solenoid, 28, is opened whenever air pressure is needed to operate the intensifier, 26. In a preferred embodiment, the air valve is part number S301YF15N8BD5 from GC Valves of Charlotte, N.C.

The intensifier, 26, is of a standard, air-over-oil variety where compressed air drives either a diaphragm or a piston, which has a relatively large area, and is physically connected to a relatively small piston that operates as a pump to produce high-pressure oil. The ratio of piston areas in a preferred embodiment is about 70:1, so air pressure acting on the large piston will produce a pressure at least 50 times larger in the oil pressure when frictional losses are subtracted. The maximum pressure is needed to level a vehicle when stationary. In a preferred embodiment, the intensifier is model number L3C-M003-65 from SC Hydraulics of Brea, Calif.

In a preferred embodiment, all the valves and restrictors of FIG. 2, are bundled together in one manifold, schematically shown as a block 3 in FIG. 1. This manifold is dynamic both hydraulically and electrically as it contains all the valves, both pilot operated and solenoid operated. Electrically, there are four solenoid valves, 24, in the control manifold that are used to add liquid to the cylinders when leveling the chassis. There are also two solenoids, level solenoid 41 and travel solenoid 42, that are used to switch between the level mode or the travel mode respectively. Hydraulically, all fluid flowing from the cylinders passes through the control manifold while in the travel mode, as does all the pilot liquid that changes the pilot operated check valves, 51 and 53, and as does all the liquid that is used to extend the cylinders while in the level mode.

The entire system depends on all the internal volumes to be filled with liquid. This is best accomplished by a vacuum method where the fully assembled system, less the accumulator, is evacuated to about one Torr, then liquid is connected and allowed to fill the entire system. Then the filled accumulator is reattached and pressurized to 200 psi of nitrogen. The initial pressure, before liquid is connected is 0.0013 atmospheres (one Torr) and the final pressure is 13.6 atmospheres for a ratio of over 10,000:1. This means that any air volume left in the system is less than one ten thousandth of the total volume of the system.

Low viscosity hydraulic liquid, as is normally used in currently made dampers, is used as the damping liquid.

PARTS LISTING

| 1A-1D | Cylinders |
|---|---|
| 2A | Upper eye ring |
| 2B | Lower eye ring |
| 3 | Control Manifold |
| 4 | Chassis |
| 5 | Spring |
| 6 | Axle |
| 7 | Wheel |
| 8 | Tubing |
| 8A | Flexible Tubing |
| 20 | Accumulator |
| 23 | 4 way, double detented, dual solenoid mode selector valve |
| 24A-24D | 3 Way, Normally open, leveling valve |
| 25 | Air compressor |
| 26 | Intensifier |
| 27 | 2 way, normally closed, solenoid air valve |
| 28 | solenoid for valve 27 |
| 30 | Piston |
| 31 | Rod |
| 32A-32D | Port from cylinders |
| 33 | Air reservoir |
| 40 | Machined surface of piston, 66, that forms dovetail, 71 |
| 41 | Solenoid to set Level mode for valve 23 |
| 42 | Solenoid to set Travel mode for valve 23 |
| 43 | Check valve to bypass damping valves |
| 44 | Blow off damping valve |
| 45 | In series damping restrictor |
| 46 | Parallel damping restrictor |
| 50 | Small diameter of piston, 66, that mates into pilot port, 69 |
| 51A-51D | Pressure to open, pilot operated check valve |
| 52 | Air pressure transducer |
| 53A1-53D2 | Pressure to close, pilot operated check valve |
| 54A-54D | Solenoid for valve 24A-24D |
| 57 | Groove in small diameter, 50, of piston, 66, for O-ring, |
| | 68 & backup rings, 70 |
| 58 | Sleeve that mates with piston, 66, to form dovetail |
| | groove, 71 |
| 59 | Sealing surface for O-ring 63 in valve 53 |
| 60 | Triangular section for crush seal of O-ring |
| 61 | Exit housing for valve 51 |
| 62 | Annular cut in housing 61 for liquid flow into valve 53 |
| 62A | Radial hole from annular cut 62 to interior of valve 53 |
| 63 | O-ring to seal outlet of valve 53 |
| 64 | Spring to open valve 53 |
| 65 | Exit port for valve 53 |
| 66 | Piston for valve 53 |
| 67 | Pilot piston housing for valve 53 |
| 68 | O-ring to seal pilot piston of valve 53 |
| 69 | Pilot piston area for valve 53 |
| 70 | Backup seal ring for O-ring 68 |
| 71 | Dovetail groove for O-ring 63 |
| 72 | Finger in outlet area, 65, to retain spring, 64 |
| 80 | Damping valve system |
| 98 | Pilot line to valves 53 |
| 99 | Pilot line to valves 51 |
| 100 | PCB |
| 101 | Accelerometer, dualtriple axis (or triple axis) |
| 102 | Signal processor, logic computer |
| 105 | Control Manifold |
| 110 | Large, Manually actuated, leak proof, 2 way valve |
| 111 | Small, Manually actuated, leak proof, 2 way valve |

It will be understood that various modifications may be made to the embodiments disclosed herein. Therefore, the above description should not be construed as limiting, but merely as exemplifications of preferred embodiments. Those skilled in the art will envision other modifications that come within the scope and spirit of the claims appended hereto. In particular, although an embodiment having two axles, four wheels and one hydraulic cylinder per wheel is used to describe the specific implementation of the inventive concepts, it is equally possible to adapt the schematics to other numbers of hydraulic cylinders, although a minimum of three cylinders is required. All patents and references cited herein are explicitly incorporated by reference in their entirety.

1. An apparatus for automatically leveling a wheeled vehicle having a plurality of axles comprising:
a. at least three single-port hydraulic cylinders positioned so as to define a plane of a chassis of said vehicle;
b. an automated levelling system comprising:
i. electronic logic for implementing Level, Lock and Travel modes;
ii. a control manifold having electronically-actuated control valving controlling hydraulic fluid flow for each single-port hydraulic cylinder, and a mode selector valve for selecting between the Travel and Lock modes, said control manifold being in electronic communication with said electronic logic;
c. an accumulator in hydraulic communication with said control manifold;
d. a hydraulic pump in hydraulic communication with said control manifold, said hydraulic pump being in electronic communication with said electronic logic; and
e. hydraulic lines that interconnect elements a-d inclusive.

2. The apparatus of claim 1 wherein said single-port hydraulic cylinder is configured to leak across the piston contained within said single-port hydraulic cylinder.

3. The apparatus of claim 1 wherein said electronic logic is contained in a PCB that is attached to said chassis of said vehicle.

4. The apparatus of claim 1 wherein the electronically-actuated control valving comprises two normally-open pressure-to-close pilot-operated check valves, a leveling valve, and a pressure-to-open pilot-operated check valve for each single-port hydraulic cylinder.

5. The apparatus of claim 1 further comprising a compressive damping circuit in fluid communication with and located between each single-port hydraulic cylinder and the accumulator.

6. The apparatus of claim 1 wherein the electronic logic comprises the logic diagram of FIGS. 12A-12C inclusive.

7. The apparatus of claim 3 wherein said PCB comprises one or more accelerometers having the capability of monitoring the x, y and z-axes either separately or individually.

8. A method of safeguarding the operation of said vehicle of claim 7 comprising:
a. monitoring the signal of all three axes of said one or more accelerometers; and
b. preventing the vehicle from entering the Lock/Level mode when any one of the three signals exceeds the noise level of said one or more accelerometers.

9. The apparatus of claim 1 further comprising a high pressure liquid subsystem in hydraulic communication with said control manifold.

10. The apparatus of claim 9 wherein the high pressure liquid subsystem comprises an air compressor, a storage tank, a pressure transducer, a two way, normally closed solenoid, an actuated air valve, and an air driven intensifier.

11. An apparatus for leveling a wheeled vehicle having a plurality of axles comprising:
a. at least three single-port hydraulic cylinders positioned so as to define a plane of a chassis of said vehicle;
b. a manual leveling system comprising a Lock/Travel valve and a Leveling valve for each single-port hydraulic cylinder;
c. an accumulator in hydraulic communication with said manual leveling system;
d. a hydraulic pump in hydraulic communication with said manual leveling system; and
e. hydraulic lines that interconnect elements a-d inclusive.

12. The apparatus of claim 11 wherein said single-port hydraulic cylinders are configured to leak across the piston contained within each cylinder.

13. The apparatus of claim 11 wherein each Lock/Travel valve and Level valve are configured to be manually operable.

14. The apparatus of claim 11 wherein each single-port hydraulic cylinder has associated with it a large, leak proof, two way valve (Lock/Travel), and a small, leak proof, two way valve (Level).

15. The apparatus of claim 11 wherein the valves are ball valves.

16. The apparatus of claim 11 further comprising a compressive damping circuit in fluid communication with and located between each cylinder and the accumulator.

17. The apparatus of claim 11 further comprising a high pressure liquid subsystem in hydraulic communication with said manual leveling system.

18. The apparatus of claim 17 wherein said high pressure liquid subsystem comprises an air compressor, a storage tank, a pressure transducer, a two way, normally closed solenoid, an actuated air valve, and an air driven intensifier.

19. An apparatus for automatically leveling a wheeled vehicle having a plurality of axles comprising:
a. at least three single-port hydraulic cylinders positioned so as to define a plane of a chassis of said vehicle;
b. an automated levelling system comprising:
i. electronic logic for implementing Level, Lock and Travel modes, said electronic logic contained in a PCB that is attached to said chassis of said vehicle, said PCB comprising one or more accelerometers having the capability of monitoring the x, y and z-axes either separately or individually;
ii. a control manifold having electronically-actuated control valving controlling hydraulic fluid flow for each single-port hydraulic cylinder, and a mode selector valve for selecting between the Travel and Lock modes, said control manifold being in electronic communication with said electronic logic;
c. an accumulator in hydraulic communication with said control manifold;
d. a hydraulic pump in hydraulic communication with said control manifold, said hydraulic pump being in electronic communication with said electronic logic;
e. a high pressure liquid subsystem in hydraulic communication with said control manifold; and
f. hydraulic lines that interconnect elements a-d inclusive.

20. A method of safeguarding the operation of said vehicle of claim 19 comprising:
a. monitoring the signal of all three axes of said one or more accelerometers; and
b. preventing the vehicle from entering the Lock/Level mode when any one of the three signals exceeds the noise level of said one or more accelerometers.
